(19) United States
(12) Patent Application Publication
(10) Pub. No.: US 2001/0055977 A1
(43) Pub. Date: Dec. 27, 2001

(54) Process for establishing a communications connection

(76) Inventor: Gerhard Holzer, Vienna (AT)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/837,364

(22) Filed: Apr. 19, 2001

(30) Foreign Application Priority Data
Apr. 20, 2000 (DE) 100 19 728.0

(51) Int. Cl. H04Q 7/20

(52) U.S. Cl. 455/461; 455/403

(57) ABSTRACT

The invention relates to a process for establishing a communications connection (KOM2) between a mobile telephone terminal (TEA) of a first subscriber (A) and a communications unit (TEB) of a second subscriber (B), and to a network server (NESERV) for the execution of this process. A communications connection (KOM1) between the mobile telephone terminal (TEA) of the first subscriber (A) and the network server (NESERV) is initiated by the mobile telephone terminal (TEA). Via the initiated communications connection (KOM1) between the mobile telephone terminal (TEA) of the first subscriber (A) and the network server (NESERV), identity data describing the identity of a vehicle (CB) are sent from the mobile telephone terminal (TEA) to the network server (NESERV). By accessing an assignment database (DB), from these identity data the network server (NESERV) determines the identity of this vehicle (CB) and a communications address assigned to the determined vehicle in the assignment database (DB). The establishment of a communications connection (KOM2) between the mobile telephone terminal (TEA) of the first subscriber (A) and the communications unit (TEB) of the second subscriber (B) is initiated by means of the determined communications address.

The invention relates to a process for establishing a communications connection between a mobile telephone terminal of a first subscriber and a communications unit of a second subscriber, in which process a communications connection between the mobile telephone terminal of the first subscriber and a network server is initiated by the mobile telephone terminal. The invention further relates to a network server for supporting the establishment of communications connections between mobile telephone terminals and communications units, the network server being provided with a first communications unit for communication with mobile telephone terminals.

The invention is based on processes for establishing a communications connection between mobile telephone terminals by means of the IN architecture (IN—Intelligent Network), as described for example in U.S. Pat. No. 5,345,502.

Mobile telephone terminals are interconnected via a telephone network comprising switching centres which perform the function of service switching points of an IN architecture. On the basis of a service indicator entered in a connection request, these switching centres initiate the establishment of a data connection to a network server which performs the function of a service control point in the IN architecture.

To establish a telephone connection between two mobile telephone terminals via the telephone network, the telephone number selected by the subscriber of the calling mobile telephone terminal is transmitted via the data connection to the network server. Then, using a database, the network server then determines the location of the subscriber to whom this telephone number is assigned and then determines route information assigned to this location. The thus determined route information is sent back via the data connection to the calling mobile telephone terminal, which then establishes a telephone connection to the called mobile telephone terminal by means of this route information.

The object of the invention is to facilitate the automatic establishment of a communications connection between a mobile telephone terminal and a communications unit with unknown communications address.

This object is achieved by a process according to the theory of claim 1 and a network server according to the theory of claim 6.

The invention is based on the principle that, for the establishment of a communications connection, identity data describing the identity of a vehicle (CB) are transmitted from a mobile telephone terminal to a network server. By accessing a database, from these identity data the network server determines a communications address and by means of the determined communications address initiates the establishment of a communications connection between the mobile telephone terminal and a communications unit assigned, in accordance with the database, to the vehicle described by the identity data.

The advantage of the invention consists in that it facilitates the addressing of unknown persons within a communications network via a very clearly defined identifying feature, which can be described at low cost and is widely recognisable, i.e. by means of their vehicle. In this way it enables unknown persons to be spontaneously contacted at any time, for example for making personal contacts, to warn them of dangers, or to inform them that their vehicle is blocking an entry.

Advantageous developments of the invention are described in the sub-claims.

In the following the invention will be explained by way of example in the form of several exemplary embodiments making reference to the attached drawing wherein:

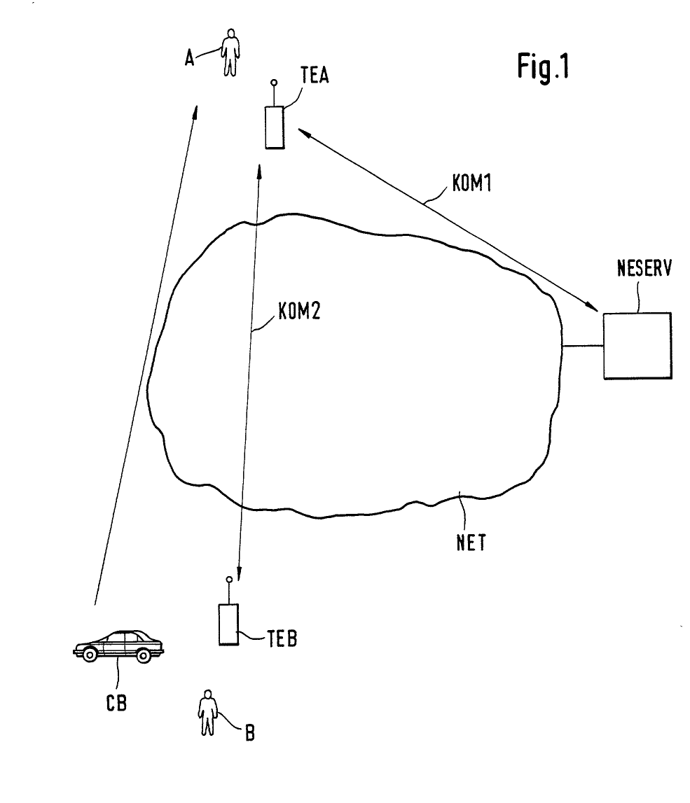

FIG. 1 is a block diagram of a communications system with a network server according to the invention;

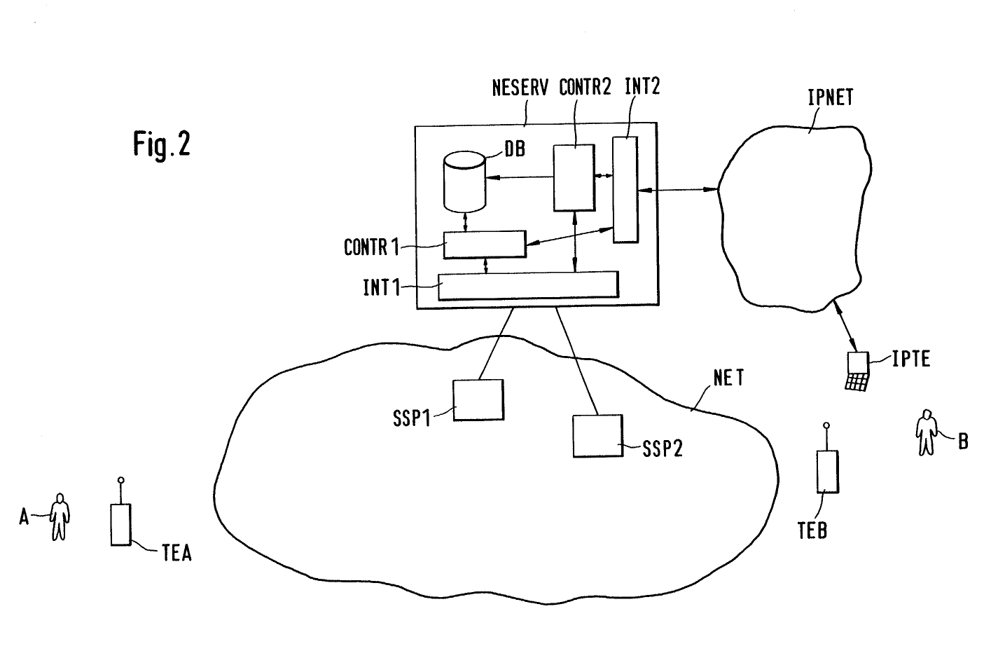

FIG. 2 is a functional diagram of the network server according to FIG. 1 for a first exemplary embodiment;

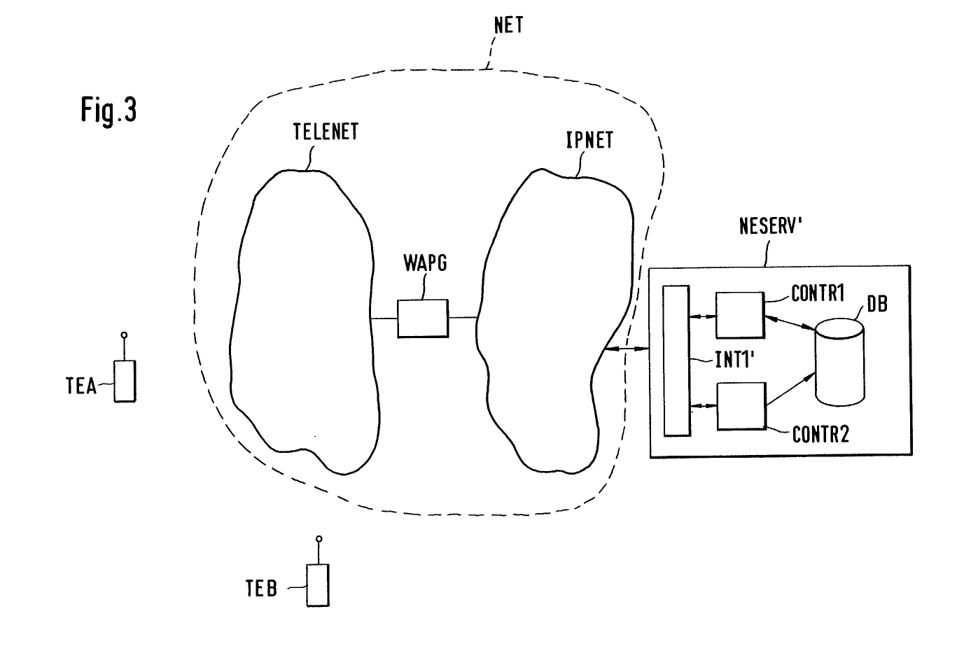

FIG. 3 is a functional diagram of the network server according to FIG. 1 for a second exemplary embodiment.

FIG. 1 illustrates a communications network NET, a network server NESERV, and two mobile telephone terminals TEA and TEB assigned respectively to a subscriber A and a subscriber B. FIG. 1 also shows a vehicle CB assigned to the subscriber B. The number of mobile telephone terminals, subscribers and vehicles has been selected by way of an example.

The communications network NET facilitates the communication between the mobile telephone terminals TEA and TEB. The communications network NET here is formed by a mobile telephone network, for example a cellular mobile telephone network complying with the GSM Standard (GSM=Global System Mobile Communication). It is also possible for the communications network NET to additionally comprise one or more further telephone network(s) (mobile telephone networks or fixed networks) or data networks which can also be assigned to different network operators.

The network server NESERV makes available a network service within the communications network NET.

The subscriber A initiates the establishment of a communications connection to the subscriber to whom the vehicle CB is assigned, for example by depressing a sequence of input keys of the mobile telephone terminal TEA or by a voice command to the mobile telephone terminal TEA.

To establish this desired communications connection, the mobile telephone terminal TEA initiates the establishment of a communications connection KOM1, preferably a data connection, between the mobile telephone terminal TEA and the network server NESERV. Then, via the initiated communications connection KOM1 between the mobile telephone terminal TEA of the subscriber A and the network server NESERV, identity data describing the identity of the vehicle CB are transmitted from the mobile telephone terminal TEA to the network server NESERV.

The identity data comprise the official registration number of the vehicle CB. However it is also possible for the identity data to comprise the type, colour, year of manufacture of the vehicle, parts of the official registration number or other standard identifying features of a vehicle, or an arbitrary combination of these features. The identity data are input by the subscriber into the mobile telephone terminal TEA, for example by typing in said data or by voice input. The speech recognition device for the speech input can also be arranged in the network server NESERV.

By accessing an assignment database, from these identity data the network server NESERV determines the identity of this vehicle and a communications address assigned to the determined vehicle in the assignment database. As shown in FIG. 1, the vehicle CB is assigned to the subscriber B to whom in turn the terminal TEB is assigned. In accordance with FIG. 1, the network server NESERV thus determines the telephone number assigned to the mobile telephone terminal TEB for example as communications address.

When the network server NESERV has determined a communications address in this way, by means of the determined communications address it initiates the establishment of a communications connection KOM2 between the mobile telephone terminal TEA of the subscriber A and the mobile telephone terminal TEA of the subscriber B.

The detailed construction of the network server according to a first exemplary embodiment will now be explained with reference to FIG. 2.

FIG. 2 illustrates the communications network NET, a communications network IPNET, the network server NESERV, a terminal IPTE and the mobile telephone terminals TEA and TEB assigned to the subscribers A and B respectively.

The communications network NET comprises a plurality of specially designed switching points which perform a service switching function in accordance with IN architecture (IN=Intelligent Network). Of these switching points, two service switching points SSP1 and SSP2 have been shown by way of example in FIG. 2.

The communications network IPNET is a data network employing the IP protocol (IP=Internet Protocol) as layer 3 communications protocol. The terminal IPTE is a terminal equipped with the communications components required for communication via the communications network IPNET. The terminal IPTE consists for example of a computer equipped with a modem or a network card.

The network server NESERV is formed by one or more computers connected via a communications medium forming the basis of a SW system platform, consisting for example of an operating system and a database system, and applications programs. When run on the system platform of the network server NESERV, these applications programs control the functions of the network server NESERV in the manner described in the following.

From a functional standpoint, the network server comprises an assignment database DB, two communications units INT1 and INT2 and two control units CONTR1 and CONTR2.

The communications unit INT1 serves for communication with mobile telephone terminals of the communications network NET. For this purpose it makes available the communications mechanisms necessary for communication with the service switching points SSP1 and SSP2. The protocol stack for this communication consists of no. 7 protocols used as transport protocol and of an INAP protocol (INAP=Intelligent Network Application Protocol) stacked thereon. It is also possible to use other transport protocols, for example a LAN protocol, for example an ETHERNET protocol (LAN=Local Area Network) on which an IP protocol is stacked. INAP protocols specially adapted to mobile telephone networks can also be used.

Within the IN architecture, the network server NESERV performs a service control function and thus represents a service control point of the communications network NET. The functions necessary for the communication between service control function-service switching function are likewise performed by the communications unit INT1.

The assignment database DB stores, in assignment to a vehicle, identity data describing the identity of this vehicle and one or more communications addresses. Communications addresses can in turn be subdivided into one or more communications classes. Communications classes are for example fixed network terminals, mobile telephone terminals, SMS (=Short Message Service), fax, answering machine, voice mail system, e-mail, pager. Accordingly, communications addresses can consist of telephone numbers but also e-mail addresses. The assignment database thus comprises for example a plurality of data records each designating a particular vehicle, and identity data describing the identity of this vehicle, one or more communications addresses, and one or more parameters. The parameters specify conditions for the selection of the communications addresses within the data record.

The assignment database DB could also be arranged outside the network server NESERV, in which case the control units CONTR1 and CONTR2 would access the assignment database DB via a communications network.

The control unit CONTR1 controls the provision of a service within the communications network NET. For this purpose, via a communications connection between a mobile telephone terminal and the network server NESERV initiated by this mobile telephone terminal, it receives identity data describing the identity of a vehicle from the mobile telephone terminal.

For this purpose the mobile telephone terminal sends the communications network NET a connection request containing a service indicator addressing the service performed by the network server NESERV. A service switching point of the communications network NET, for example the service switching point SSP1, is triggered by this connection request and sends a corresponding service request message to the network server NESERV, which is thereby triggered for the requested connection. The identity data can be directly transmitted to the network server NESERV in the connection request and in the service request message.

However it is also possible for the control unit CONTR1 to initiate the establishment of a further connection, for example of a voice channel, between the mobile telephone terminal and the network server NESERV, for example the establishment of a connection to a service support system, equipped with a speech recognition device, of the network server NESERV. The identity data are then transmitted to the control unit CONTR1 via this further connection.

Upon the reception of the identity data, by accessing the assignment database DB, from these identity data the control unit CONTR1 determines the identity of this vehicle and a communications address which is assigned to the determined vehicle in the assignment database DE.

For this purpose, using the identity data as access key, the control unit CONTR1 accesses the assignment database DB and from the data records stored in the assignment database DB selects the data record whose identity data corresponds most exactly to the received identity data. If only one communications address is entered in the data record the control unit reads this communications address from the assignment database DB and specifies this communications address as the communications address assigned to the determined vehicle.

If several communications addresses are entered in the data record, using the parameter data stored in the selected data record, the control unit selects one of these communications addresses and specifies this communications address as the communications address assigned to the determined vehicle.

Here the parameter data define a personal user profile assigned to the vehicle. If, in the assignment database DB, a set of several communications addresses is assigned to a vehicle, by means of this personal user profile assigned to the vehicle, the control unit selects one or also several (application of further criteria) communications addresses from this set of communications addresses.

The entry of parameter data in the assignment database DB or the analysis of these parameter data can also be omitted.

It is also possible for the control unit CONTR1 to determine the identity of the mobile telephone terminal which has initiated the communications connection to the network server NESEV. If, in the assignment database DB, a set of several communications addresses is assigned to the determined vehicle, by means of the personal user profile assigned to the determined mobile telephone terminal, the control unit CONTR1 then selects one or several communications addresses from this set of communications addresses in order to initiate the communications connection. These personal user profiles can be stored in a separate part of the assignment database DB or in the data record assigned to the vehicle which is associated with the subscriber of the determined mobile telephone terminal. The personal user profile assigned to the determined mobile telephone terminal can for example designate the communications class via which the communications connection is to be established.

It is of course also possible to analyze both the personal user profile of the determined mobile telephone terminal and also the personal user profile of the determined vehicle to determine the communications address. It is also possible to use other criteria for selecting the communications address, for example data input by the mobile telephone terminal subscriber, time- or location information.

When the control unit CONTR1 has determined the communications address, by means of the determined communications address it initiates the establishment of a communications connection between the mobile telephone terminal from which it has received the identity data and the communications unit addressed via the determined communications address.

The control unit CONTR1 can for example initiate the establishment of this communications connection by sending a corresponding control command, containing the determined communications address, to a telephone network to which this mobile telephone terminal is assigned, thus for example by sending an appropriate control command to the communications network NET. For this purpose it transmits, for example, an INAP command to the service switching point SSP1 instructing the latter to forward the “waiting” connection request with this communications address as telephone number of the called subscriber and thus to initiate a call redirection to this communications address. Additionally, by means of an appropriate control command, it can also initiate the connection establishment to a SMS server or an internet gateway.

Another possibility is for the control unit CONTR1 to send back the communications address to the mobile telephone terminal, which automatically initiates the connection establishment upon the reception of this data.

The control unit CONTR2 and the communications unit INT2 serve to enter data records in the assignment database DB. These two units could also be omitted.

The communications unit INT2 makes available the communications mechanisms required for communication via the communications network IPNET.

The control unit CONTR2 facilitates the entry into the assignment database DB of identity data and communications addresses assigned to vehicles. Thus, by means of the control unit CONTR2, subscribers of a communications network, for example subscribers of the communications network NET, can independently enter data records for their vehicles in the assignment database DB. In this case the control unit CONTR2 makes available a user interface for the inputting of these data into the assignment database DB.

Access to the control unit CONTR2 preferably takes place via the communications unit INT2, for example by means of the terminal IPTE. The control unit CONTR2 thus makes a WEB interface available to subscribers. Access to the control unit CONTR2 can also take place by means of a terminal supporting the WAP protocol (WAP=Wireless Application Protocol). However it is also possible for the control unit CONTR2 to provide, in place of or in addition to this interface, an IN service enabling the entry of data records in the assignment database DB using a normal terminal, preferably a mobile telephone terminal. In this case access to the control unit CONTR2 would take place via the communications unit INT1.

The detailed construction of a network server according to a second exemplary embodiment will now be explained with reference to FIG. 2.

FIG. 2 illustrates the communications network NET together with a network server NESERV′ and the mobile telephone terminals TEA and TEB.

In this exemplary embodiment the communications network NET is formed by a communications network TELENET and a communications network IPNET′ which are interconnected via a WAP gateway WAPG.

The WAP gateway WAPG translates “normal” internet documents into documents conforming to the WAP standard.

The communications network TELENET is a telephone network which facilitates voice communication between the mobile telephone terminals TEA and TEB. The communications network IPNET′ is a data network corresponding to the communications network IPNET shown in FIG. 2.

The network server NESERV′ is an internet server which provides services in the communications network TELENET using the WAP protocol. The mobile telephone terminal TEA is equipped with an additional functionality which enables it to communicate with the network server NESERV′ via the WAP gateway WAPG by means of the WAP protocol. When the network server NESERV′ is appropriately constructed, it is also possible to omit the WAP gateway WAPG.

The construction of the network server NESERV′ corresponds to that of the network server NESERV according to FIG. 2 apart from the differences described in the following. From a functional standpoint it comprises a communications unit INT1′, the control units CONTR1 and CONTR2 and the assignment database DB which are designed in accordance with FIG. 2.

The communications unit INT1′ comprises the function units required for communication via the communications network IPNET. It also controls the dialogue with the mobile telephone terminal TEA and provides the communications functions required for making available a WAP-based service within the communications network TELNET. Depending upon the configuration of the communications unit INT1′, it is possible to omit the WAP gateway WAPG. When the communications unit INT1′ is appropriately configured, the network server thus can be directly connected to the communications network TELENET.

Either a special client for the type of connection establishment described here with a special user interface is pre-installed in the mobile telephone terminal TEA, or the mobile telephone terminal TEA comprises a browser onto which a corresponding input page, for inputting the identity data describing the identity of a vehicle, is downloaded from the network server NESERV. An interactive dialogue with the network server NESERV can also be facilitated via a user interface formed in this way.

The identity data input via this user interface are transmitted to the network server NESERV by means of a communications connection, initiated by the mobile telephone terminal TEA, via the WAP gateway WAPG and the communications network IPNET′. Then, for example by sending a corresponding control command to the communications network TELENET, by means of the determined communications address the network server NESERV initiates the establishment of a communications connection between the mobile telephone terminal TEA and the communications unit assigned to the determined communications address.

1. A process for establishing a communications connection (KOM2) between a mobile telephone terminal (TEA) of a first subscriber (A) and a communications unit (TEB) of a second subscriber (B), in which process a communications connection (KOM1) between the mobile telephone terminal (TEA) of the first subscriber (A) and a network server (NESERV) is initiated by the mobile telephone terminal (TEA), characterised in that, via the initiated communications connection (KOM1) between the mobile telephone terminal (TEA) of the first subscriber (A) and the network server (NESERV), identity data describing the identity of a vehicle (CB) are transmitted from the mobile telephone terminal (TEA) to the network server (NESERV), that by accessing an assignment database (DB), from these identity data the network server (NESERV) determines the identity of this vehicle (CB) and a communications address assigned to the determined vehicle in the assignment database (DB), and that the establishment of a communications connection (KOM2) between the mobile telephone terminal (TEA) of the first subscriber (A) and the communications unit (TEB) of the second subscriber (B) is initiated by means of the determined communications address.

2. A process according to claim 1, characterised in that the identity data describe the registration number of the vehicle.

3. A process according to claim 1, characterised in that a telephone number assigned to the communications unit (TEB) of the second subscriber (B) is determined as communications address by the network server (NESERV).

4. A process according to claim 1, characterised in that when, in the assignment database (DB), a set of several of communications addresses is assigned to a vehicle, by means of a personal user profile assigned to the determined vehicle, one or more communications addresses are selected by the network server (NESERV) from this set of communications addresses for the initiation of the communications connection (KOM2).

5. A process according to claim 1, characterised in that the identity of the mobile telephone terminal (TEA) which has initiated the communications connection (KOM1) to the network server (NESERV) is determined by the network server (NESERV), and that when, in the assignment database (DB), a set of several communications addresses is assigned to the determined vehicle, by means of a personal user profile assigned to the determined mobile telephone terminal (TEA) one or more communications addresses are selected by the network server (NESERV) from this set of communications addresses for the initiation of the communications connection (KOM2).

6. A network server (NESERV) for supporting the establishment of communications connections between mobile telephone terminals (TEA) and communications units (TEB), wherein the network server (NESERV) is provided with a first communications unit (INT1) for communication with mobile telephone terminals, characterised in that the network server (NESERV) is provided with a control unit (CONTR1) which is designed such that via a communications connection (KOM1), initiated by a mobile telephone terminal (TEA), between this mobile telephone terminal (TEA) and the network server (NESERV), it receives identity data describing the identity of a vehicle (CB) from the mobile telephone terminal (TEA), and that upon the reception of the identity data, by accessing an assignment database (DB), from these identity data it determines the identity of this vehicle (CB) and a communications address assigned to the determined vehicle (CB) in the assignment database (DB), and that the control unit (CONTR1) is further designed such that by means of the determined communications address it initiates the establishment of a communications connection (KOM2) between the mobile telephone terminal (TEA) from which it has received the identity data and a communications unit (TEE) assigned to the determined communications address.

7. A network server according to claim 6, characterised in that the control unit (CONTR1) is further designed such that it initiates the establishment of the communications connection (KOM2) between the mobile telephone terminal (TEA) from which it has received the identity data and the communications unit (TEE) in that it transmits an appropriate control command containing the determined communications address to a telephone network to which this mobile telephone terminal (TEA) is assigned.

8. A network server according to claim 6, characterised in that the network server is provided with a further control unit (CONTR2) which is designed such that it facilitates the entry in the assignment database (DB) of identity data and communications addresses assigned to vehicles by a subscriber of a communications network (NET, IPNET), who is associated with the relevant vehicle.

9. A network server according to claim 6, characterised in that the network server (NESERV) is a service control point of a telephone network.

10. A network server (NESERV) according to claim 6, characterised in that the network server is an internet server which makes services available in a telephone network by means of the WAP protocol.
